(19) United States
(12) Patent Application Publication
(10) Pub. No.: US 2019/0085159 A1
(43) Pub. Date: Mar. 21, 2019

(54) DIIOCYANATE-SCAVENGING PACKAGING LAMINATES

(71) Applicant: Bemis Company, Inc., Neenah, WI (US)

(72) Inventors: James C. Huang, Oshkosh, WI (US); Devanshu V. Mehta, Menasha, WI (US)

(21) Appl. No.: 16/082,432

(22) PCT Filed: Mar. 7, 2016
(86) PCT No.: PCT/US16/21134

§ 371 Date: Sep. 5, 2018

(51) Int. Cl. C08L 23/06; C08L 23/08; C08G 65/00; C08G 65/34; B29C 47/00

(52) U.S. Cl. CPC C08L 23/06; C08L 23/0815; B29C 47/0026; C08G 65/34; C08G 65/002

(57) ABSTRACT

The present invention is directed to packaging laminates for containing a food or pharmaceutical/medical product which includes an exterior film, a multilayer interior film comprising a diisocyanate-scavenging layer and an adhesive-contact layer, and a polyurethane adhesive layer bonding the exterior film to the multilayer interior film. The present invention reduces the amount of any unreacted diisocyanate precursor and primary amines which can migrate to a product in packaging assemblies formed with a polyurethane adhesive. This is achieved when an interior film (commonly known as a sealant film) includes a layer comprising a non-polymeric polyol which is not in direct contact with the polyurethane adhesive. With this approach, the nonpolymeric polyol reacts with any residual diisocyanate and/or primary amines which migrates from the polyurethane adhesive through the laminated assembly and thus, neutralizes any potential undesirable effects of these compounds.

### BACKGROUND OF THE INVENTION

The present invention relates generally to primary packaging for food and pharmaceutical products, and in particular to packaging laminates for scavenging residual diisocyanate, including aromatic diisocyanate and scavenging primary amines, including primary aromatic amines which may remain in the packaging assembly.

Polymers used in the packaging arts that do not bind together by standard coextrusion methods can be joined by lamination. Lamination of flexible materials (common films are PET, PP, polyethylene (PE), polyamide (PA), but also paper and aluminum foil) used for packaging materials in contact with food is today usually done with reactive two-component adhesives, solvent-based, water-based or solvent-free (100% solids) based on polyurethane chemistry.

Solventless polyurethane adhesives are the most widely used of the 100% solids lamination adhesive products in the packaging arts. These are two-part adhesive systems which comprise a diisocyanate precursor, typically an aromatic diisocyanate precursor, and a polyol (polyether-based or polyester-based) precursor. These adhesives typically contain excess unreacted diisocyanate precursor which lowers the viscosity and thus making them easier to handle and adhere to a variety of substrates. Often aromatic diisocyanate precursors are selected to obtain good adhesion under moist and low temperature conditions. Aromatic diisocyanate precursors are also cheaper than aliphatic systems and for this reason are more commonly used than aliphatic diisocyanate precursors.

However, even though the adhesive is sufficiently cured to develop good bond strength between two laminated substrates, some residual unreacted diisocyanate precursor may be present in the bonded assembly. Any residual amount of unreacted diisocyanate is considered undesirable since they have a tendency to migrate and react with other components of the laminated assembly weakening its structural integrity. One approach to reducing the amount of unreacted diisocyanate is to place the laminated assembly in storage for several weeks or days prior to its use to allow any unreacted diisocyanate to further react with any remaining polyol. This strategy adds considerably to the cost of manufacture because of added inventory management and increases in order-to-delivery time which reduces manufacturing efficiency.

While the laminated assembly is in storage, unreacted diisocyanate may also react with moisture trapped during the coating of the adhesive, moisture from an atmosphere under high humidity or moisture from a food product. Diisocyanate and water react to form primary aliphatic amines from aliphatic diisocyanates and primary aromatic amines from aromatic diisocyanate. Primary aromatic amines may be consumed by its continuing reaction with diisocyanate still present in the adhesive to form polyurea. However, unreacted primary aromatic amines can also migrate within packaging laminate assembly to the packaged product. Regulatory agencies limit the amount of migratable primary aromatic amines in applications that come into contact with people because of their potential toxicity. Accordingly, manufacturers of packaging materials need to reduce the level of primary aromatic amines that can be transferred from the package into foodstuffs and pharmaceuticals.

For food and pharmaceutical containers, pouch, bags, and the like, the contact between the container and the food or pharmaceutical product should not result in appreciable amounts of unreacted diisocyanate and/or primary aromatic amine being present in or on the packaged product.

### SUMMARY OF THE INVENTION

The present invention is directed to packaging laminates for containing a food or pharmaceutical/medical product which includes: i) an exterior film, ii) a multilayer interior film comprising a diisocyanate-scavenging layer and an adhesive-contact layer and, optionally, a separate product-contact layer, and iii) a polyurethane adhesive layer bonding the exterior film to the multilayer interior film. The present invention reduces the amount of any unreacted diisocyanate precursor and primary amines which migrate to a product in packaging assemblies formed with a polyurethane adhesive. This is achieved when an interior film (commonly known as a sealant film) includes a layer comprising a non-polymeric polyol which is not in direct contact with the polyurethane adhesive. With this approach, the non-polymeric polyol reacts with any residual diisocyanate which migrates from the polyurethane adhesive through the laminated assembly and thus, neutralizes any potential undesirable effects of these migrating compounds. A further advantage of this invention is that it improves manufacturing efficiency by shortening order-to-delivery times because there is no longer the need to store the packaging laminates after they have been made to reduce the level of diisocyanate and/or primary aromatic amines.

to As used herein the terms “exterior” and “interior” refer to the outer and inner surfaces of a container, respectively, formed from the packaging laminates of the present invention. Accordingly, the interior film of the present invention may have a layer which is in direct contact with a packaged product (which is referred to herein as the “product-contact layer'). In some preferred embodiments, the product-contact layer is a separate layer apart from the diisocyanate-scavenging layer. In other preferred embodiments, the product-contact layer and the diisocyanate-scavenging layer are the same layer. The interior film may also include film layers which function as water, gas and/or chemical barriers. The exterior film of the present invention will not be in direct contact with the packaged product and may include at least one layer which functions as a water and/or gas barrier. The interior film layer comprising the highest concentration of non-polymeric polyol is referred to as the “diisocyanate-scavenging layer.” It is contemplated that the laminate assemblies of the present invention can be converted into various packaging products, especially food packaging laminates, including but not limited to bags, pouches, stand-up pouches, zipped pouches, over-wraps, and trays; pharmaceutical packaging laminates including blister packaging; and medical packaging for surgical instruments and medical devices.

Non-Polymeric Polyols

An important aspect of the present invention is that the diisocyanate-scavenging layer of the multilayer interior film comprises a non-polymeric polyol. As used throughout this disclosure, the term “non-polymeric polyol” refers to any molecule or oligomer having two or more pendant hydroxy groups (—OH) attached thereto.

In some preferred embodiments, the non-polymeric polyol can be defined as a monosaccharide, a disaccharide or an oligosaccharide. Monosaccharides have the general molecular formula (CH₂O)ₙ where n can be 3, 5 or 6 and may include, but are not limited to such sugars as glucose, galactose, fructose, and ribose. Disaccharides are defined as two monosaccharide units linked together and may include, but are not limited to sucrose, maltose and α-lactose. Oligosaccharides are defined as three or more monosaccharide units linked together and may include but are not limited to such materials as raffinose, maltotriose, maltotetralose, maltopentalose, and meibiose. The non-polymeric polyol may have a linear, a cyclic or a combination of linear and cyclic chemical structure. In such embodiments, the non-polymeric polyol can be defined as a cyclodextrin consisting of six, seven and eight glucose moieties, commonly referred to as α-, β-, and γ-cyclodextrin, respectively.

An important aspect of the present invention is the use of a layer separating the polyurethane adhesive layer and the diisocyanate-scavenging layer. This layer which is the adhesive-contact layer of the multilayer interior film of the present invention acts as a barrier to prevent the non-polymeric polyol from migrating from the diisocyanate-scavenging layer and reacting with the components of the polyurethane adhesive layer. Without such a layer, the properties of the polyurethane adhesive could be adversely affected.

In some preferred embodiments of the present invention, the non-polymeric polyol has a melting point (m.p.) of at least 200° C. which also minimizes and/or eliminates its migration from the diisocyanate-scavenging layer. In such embodiments, the non-polymeric polyol is solid at room temperature and may be readily melt blended with various thermoplastic resins using conventional compounding methods to a desired weight ratio. In such embodiments, the non-polymeric polyol remains solid and well-distributed in the diisocyanate-scavenging layer during the co-extrusion process with other film layers.

In some other preferred embodiments, the non-polymeric polyol can be defined by the generic chemical structure:

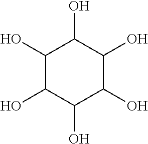 [SMILES: OC1C(O)C(O)C(O)C(O)C1O]

In such preferred embodiments, the non-polymeric polyol is cyclohexane-1, 2, 3, 4, 5, 6-hexol which has nine possible stereoisomers suitable for use in the present invention. One such preferred embodiment of cyclohexane-1, 2, 3, 4, 5, 6-hexol is (1R, 2R, 3S, 4S, 5R, 6S)-cyclohexane-1, 2, 3, 4, 5, 6-hexol, commonly referred to as vitamin B8 or inositol (also known as “myo-inositol”). Inositol' is a water-soluble molecule having a molar mass of 180.16 g/mol; a density of 1752 g/cm³, and a melting point of between 225 to 227° C. Inositol is generally recognized as safe (GRAS) for human consumption by the USA-FDA and widely used as a nutritional supplement in food and beverage industries. Inositol or (1R, 2R, 3S, 4S, 5R, 6S)-cyclohexane-1, 2, 3, 4, 5, 6-hexol has the following stereospecific chemical structure:

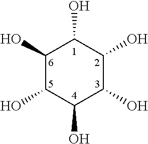 [SMILES: O[C@H]1[C@H](O)[C@@H](O)[C@H](O)[C@@H](O)[C@H]1O]

Diisocyanate-Scavenging Layer

In some preferred embodiments, the diisocyanate-scavenging layer comprises between 0.1 wt-% (1000 ppm) and 5.0 wt.-% (50,000 ppm) of the non-polymeric polyol relative to the total weight of the diisocyanate-scavenging layer. In other preferred embodiments, the diisocyanate-scavenging layer comprises between 1.0 wt.- % (10,000 ppm) and 5.0 wt- % (50,000 ppm) of the non-polymeric polyol relative to the total weight of the diisocyanate-scavenging layer. In these preferred embodiments, the non-polymeric polyol is incorporated into a thermoplastic resin. Typical thermoplastic resins which may be used to form the diisocyanate-scavenging layer include, but not limited to polyolefins such as high density polyethylene, low density polyethylene, linear low density polyethylene, ethylene/a-olefin copolymer, cyclic olefin copolymer, ethylene vinyl acetate copolymer, polypropylene, polybutylene; polyimide; polyester and blends thereof. In some preferred embodiments, the diisocyanate-scavenging layer consists essentially of only the non-polymeric polyol and the thermoplastic resin or blends thereof. In such embodiments, the diisocyanate-scavenging layer is void of any catalyst which promotes the reaction of isocyanates or diisocyanates with non-polymeric polyols. The term “diisocyanate-scavenging” means reacting, absorbing, consuming, or reducing the amount of diisocyanate from a given structure. Diisocyanates have a generic chemical structure below where R represents an aliphatic, aromatic or combination of aliphatic and aromatic chemical moiety:

O═C═N—R—N═C═O

It should be understood that the term “diisocyanate” used herein may include aromatic and aliphatic polyisocyanate dimers, trimers, oligomers, polymers, isocyanate functional prepolymers, and mixtures thereof. The term “diisocyanate” also includes triisocyanates, tetracyanates and other polyisocyanate compounds and polymers, and mixtures thereof.

There are several methods which could be used to produce the diisocyanate-scavenging layer compositions of the present invention. All the components of the diisocyanate-scavenging layer may be dry blended in the required weight ratio in a suitable device such as a tumble blender. The resulting dry blend is then melted in suitable equipment such as an extruder. Alternatively, a masterbatch could be prepared by metering the layer components directly into a single- or twin-screw extruder. The specific conditions for operating a single-screw extruder will differ from that of a twin-screw extruder, but those skilled in the art can readily determine the necessary operating conditions needed to prepare masterbatches suitable for use with the present invention.

Since the non-polymeric polyol reacts with migrating unreacted diisocyanate precursor, the diisocyanate-scavenging layer may also include urethane-type compounds as a consequence of these chemical interactions.

One useful method of varying the concentration of non-polymeric polyol relative to the total weight of the multilayer interior film is by the changing the relative thickness of the diisocyanate-scavenging layer. One skilled in the art will recognize that the basis weight of the individual layer corresponds to its thickness. Accordingly, increasing the basis weight (lbs./ream) of a layer having a particular weight percentage of non-polymeric polyol increases the concentration of non-polymeric polyol (ppm) relative to the total weight of the film.

As previously mentioned, it is also contemplated that the diisocyanate-scavenging layer may also function as the product-contact layer in the present invention. In such embodiments, the diisocyanate-scavenging may comprise the non-polymeric polyol and a heat sealable thermoplastic resin such as, but not limited to, polyethylene homopolymers and copolymers including high density polyethylene, low density polyethylene, linear low density polyethylene, ethylene/α-olefin copolymer, cyclic olefin copolymer, ethylene vinyl acetate copolymer, polypropylene, polyethylene/polypropylene copolymer, polybutylene, ionomer and blends thereof. In such embodiments, a separate product-contact layer is not required.

Multilayer Interior Film

The multilayer interior film having the two required adhesive-contact and diisocyanate-scavenging layers may have additional film layers. In some preferred embodiments, these additional layers can be positioned between the diisocyanate-scavenging layer and product-contact layer. It is also contemplated that additional film layers may be positioned between the diisocyanate-scavenging layer and the adhesive-contact layer. In such embodiments, the additional layer may be composed of water, chemical and/or gas barrier materials which are well known to those skilled in the art.

The multilayer interior file may be fabricated by several different conventional methods known in the art including blown film coextrusion, slot cast coextrusion, extrusion lamination, extrusion coating and combinations thereof. In a preferred embodiment, the multilayer interior film was produced using a coextrusion blown film line. In this method, the line was equipped with multiple extruders which fed into a multi-manifold circular die head through which the film layers are forced and formed into a cylindrical multilayer film bubble. The bubble was quenched, then collapsed and formed into a multilayer film. Films produced using blown film processes are known in the art and have been described, for example, in The Encyclopedia of Chemical Technology, Kirk-Othmer, 3rd ed., John Wiley & Sons, New York, 1981, Vol. 16, pp. 416-417 and Vol. 18, pp. 191-192, the disclosures of which are incorporated herein by reference. Typically, the resins and any additives forming one or more film layers were introduced to an extruder where the resins were melt-plastified by heating and then transferred to an extrusion (or coextrusion) die for formation into the bubble or tube. If desired, resins may be blended or mechanically mixed by well-known methods using commercially available equipment including tumblers, mixers or blenders, and well-known additives such as processing aids, slip agents, anti-blocking agents, pigments and mixtures thereof may be incorporated into the resin by blending prior to extrusion. The extruder and die temperatures will generally depend upon the particular resin(s) containing mixtures being processed, and suitable temperature ranges for commercially available resins are generally known in the art or are provided in technical bulletins made available by resin manufacturers. The specific conditions for operation of any specific extrusion equipment can be readily determined by one skilled in the art. After formation, the bubble is cooled, collapsed, slit, and wound around a roller for further processing.

A separate product-contact layer of the multilayer interior film may include any thermoplastic material used for heat sealing a packaging web to itself or other packaging components. In some preferred embodiments, the product-contact layer is a heat sealable thermoplastic resin such as, but not limited to, polyethylene homopolymers and copolymers including high density polyethylene, low density polyethylene, linear low density polyethylene, ethylene/α-olefin copolymer, cyclic olefin copolymer, ethylene vinyl acetate copolymer, polypropylene, polyethylene/polypropylene copolymer, polybutylene, ionomer and blends thereof. The product-contact layer may also include a pressure sensitive adhesive or a blend of pressure sensitive adhesive and some other heat sealable thermoplastic resin as mentioned above. For some applications, the product-contact layer has a composition which functions as a chemical barrier and/or water barrier and/or gas barrier.

The adhesive-contact layer of the multilayer interior film may be any thermoplastic substrate which will adhere to the polyurethane adhesive. In some preferred embodiments, the adhesive contact layer is any thermoplastic which is readily coextruded together with the diisocyanate-scavenging and product-contact layers. In some preferred embodiments, the composition of the adhesive-contact layer is identical to the composition of the product-contact layer,

Exterior Film

The exterior film of the present invention may comprise any material which readily bonds to polyurethane adhesive. Such materials include mono- and multilayer thermoplastic substrates such as polyester, polyimide and polyolefin films and combinations thereof. In some preferred embodiments, the exterior film comprises an oriented monolayer film. Such films include uniaxial- or biaxial oriented polyethylene terephthalate, oriented nylon and oriented polypropylene. Other suitable materials for use as an exterior film include paper, paperboard, cardboard and cellulose fiber-containing substrates.

Polyurethane Adhesive

The polyurethane adhesive suitable for use in the present invention may be any two-component precursor system comprising diisocyanate precursor and polyol precursor. The diisocyanate precursors are di- or polyfunctional isocyanates containing two or more than two —NCO (isocyanate) groups per molecule or polymer repeating unit. These can be aliphatic, cycloaliphatic, polycyclic or aromatic in nature such as toluene diisocyanate (TDI), methylene diphenyl diisocyanate (MDI), xylene diisocyanate (XDI), meta-tetramethylxylylene diisocyanate (TMXDI), hydrogenated xylene diisocyanate (HXDI), naphthalene 1,5-diisocyanate (NDI), phenylene diisocyanate (PPM), 3,3′-dimethyldiphenyl-4, 4′-diisocyanate (DDDI), 1,6 hexamethylene diisocyanate (HDI), 2,2,4-trimethylhexamethylene diisocyanate (TMDI), isophorone diisocyanate (IPDI), 4,4′-dicyclohexylmethane diisocyanate (H12MD1), norbornane diisocyanate (NDI), and 4,4′-dibenzyl diisocyanate (DBDI). The polyol precursors are di- or polyfunctional alcohols containing two or more two —OH (hydroxy) groups per molecule or polymer repeating unit. The polyol precursors may be synthesized to include ether, ester or ether/ester linkages as part of its chemical structure. Such polyols may be referred to as polyether polyols, polyester polyols and poklyether/polyester polyols, respectively. Polyurethane adhesives are well known in the art and a number of suitable examples are commercially available. Examples of such adhesives include, but are not limited to, those sold under the trade name MOR-FREE™ by The Dow Chemical Company, Inc. (Midland, Mich.) and LOCTITE® LIOFOL by Henkel AG & Company (Dusseldorf, Germany).

### BRIEF DESCRIPTION OF THE DRAWINGS

Further features and advantages of the present invention will become apparent from the following detailed description, taken in combination with the appended drawings, in which:

FIG. 1 illustrates a schematic of one preferred embodiment of a packaging laminate according to the present invention.

### DETAILED DESCRIPTION OF THE INVENTION

The present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

Preparation of Masterbatch of the Diisocyanate Scavenging Layer

Compounding of a masterbatch for the diisocyanate-scavenging layer was done in advance to make the multilayer interior film. The masterbatch was compounded using APV MP2050 co-rotating 50 mm twin-screw extruder with a dual segment barrel (10:1 and 15:1) 25:1 UD machine. The drive was a 38 HP motor with a maximum screw speed of 600 RPM. The extruder has several barrel-temperature zones, including the die, and was water cooled. The extruder was heated to a temperature from 82° F. (180° C.) to 193° C. (380° F.). The screw speed was kept at about 300 RPM's. The specific conditions of the extruder can vary depending upon the specific thermoplastic resin and non-polymeric polyol used to form the diisocyanate scavenging layer and the relative ratio of these components. The specific conditions of operation can readily be determined by one skilled in the art. The extruder extruded the layer masterbatch composition as strands which were then cooled and cut into pellets for subsequent use. In one preferred embodiment, a masterbatch was formed under the conditions described above which included a composition of about 96 wt.- % of a butene linear low density polyethylene (LLDPE) (Westlake LF1040AA) having a melt index of 0.8 gram/10 min. and a density of 0.922 gram/cm³ supplied by Westlake Chemical Corporation (Houston, Tex.); about 4 wt.- % of a non-polymeric polyol, inositol (Hard Eight. Nutrition LLC, Henderson, Nev.). It is also contemplated that a masterbatch can be prepared without the use of any processing aids.

Preparation of Laminates

Any suitable method of making flexible laminates can be used to form the laminates of the present invention. One specific method for use with solventless polyurethane adhesives included combining the diisocyanate precursor and the polyol precursor of the adhesive and then immediately sending the mixed components onto the lamination gravure rollers of a conventional plastic film laminator. In one preferred embodiment, a 1:1 ratio of diisocyanate to polyol precursor was used. Useful coating temperatures range from 20° C. to 75° C. Lower temperatures are preferred during the process in order to extend the working life of the adhesive composition. The mixed adhesive was then applied to an in-line corona treated surface of the exterior film. The coating weight of the adhesive may vary broadly depending on the desired properties of the laminate. Useful adhesive coating weights include from 0.5 grams/meter² to 3 grams/meter² and preferably from 1.5 grams/meter² to 2.5 grams/meter². Once coated, the exterior film was mated to the multilayer interior film by pressing the exterior film/adhesive/interior film structure together by use of nip rollers. The laminate was then wound onto a production roll for curing of the adhesive.

Preparation of Pouches

Test samples of different laminates were removed from their production roll after 24 hours, 48 hours and 72 hours curing times. A 50 in² pouch was formed from the laminate samples using a conventional heat sealing apparatus, and then filled with 200 mL of food simulant (3% acetic acid solution) so that there was minimal headspace within the pouch. Specific heat sealing conditions such as sealing temperature, sealing pressure and sealing time can vary depending upon the specific thermoplastic used for the food-contact layer and would be readily known to one skilled in the art. The food simulant was prepared by diluting 1.5 liters of glacial acetic acid to 50 liters using ultra purified water.

Efficacy of the Diisocyanate-Scavenging Layer

The approach taken to test the efficacy of the diisocyanate-scavenging layer was to make pouches after the three post-lamination times, fill the pouches with a suitable food simulant, and seal and store the pouches. After filling, the pouches were kept in an air circulated oven for 2 hours at 70° C., after which a 20 mL sample of food simulant within the pouch was retrieved. The amount of extractable primary aromatic amines in the food simulant was then measured. One method of determining the amount of migratory amines is with the use of HPLC/MS coupling which measures the amines directly. Because it was believed that the lamination adhesive used for this study (MOR-FREE™ 403A/MOR-FREE™ C-117) contained three structural isomers of methylene diphenyl diisocyanate (MDI), 2,2′-methylene diphenyl diisocyanate, 2,4′-methylene diphenyl diisocyanate and 4,4′-methylene diphenyl diisocyanate, the corresponding primary aromatic amines of these diisocyanate isomers were detected via liquid chromatography/mass spectrometry. The specific aromatic amines detected were 2,2′-methylenedianiline (2,2′-MDA), 2,4′-methylenedianiline (2,4′-MDA) and 4,4′-methylenedianiline (4,4′-MDA), A API 4000™ LC/MS/MS system manufactured by AB Sciex LLC (Framingham, Mass.) which combines high pressure liquid chromatography (HPLC) with a quadrupole mass spectrometry (MS) was used to determine the concentration of the three primary aromatic amine isomers in each sample of food simulant. The retention time and concentration for each primary aromatic amine isomer were calibrated using commercial available analytical standards for each primary aromatic amine isomer using a Phenomenex® Luna C18(2) HPLC column manufactured by Phenomenex Inc. (Torrance, Calif.). A 1 mL aliquot of the 20 mL sample of food simulant within each pouch was placed into an injection vial which had a 2 μL portion of analytical standards of each primary aromatic amine isomer.

### WORKING EXAMPLES

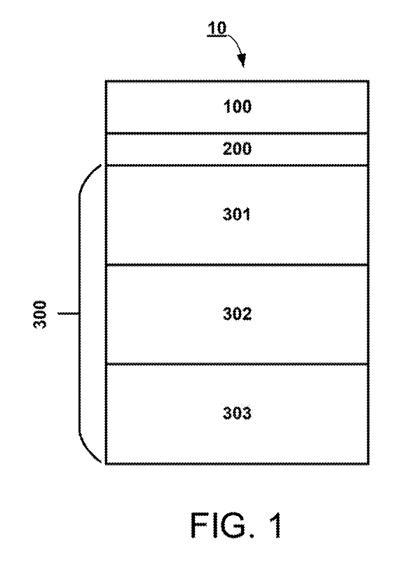

FIG. 1 illustrates one preferred embodiment of a laminate according to the present invention. In this drawing, laminate 10 comprises an exterior film 100, a polyurethane adhesive layer 200, and a multilayer interior film 300 comprising an adhesive-contact layer 301, a diisocyanate-scavenging layer 302 and a product-contact layer 303.

In the following Example 1, the thickness of the total exterior film 100 vary between 11.2 and 12.2 micron (0.44 and 0.48 mil), or had a total basis weight of 9.5 lbs./ream, the total thickness of the polyurethane adhesive 200 was between 1.27 and 12.7 micron (0.05 and 0.5 mil), or had a basis weight of 1.2 lbs./ream, and the total thickness of multilayer interior film 300 was about 63.5 micron (2.5 mil) or had a total basis weight of 36.22 lbs./ream. This example is intended to be representative of a specific embodiment of the invention and is not intended to be limiting to the scope of the invention.

### Example 1

The Example 1 had a structure and layer compositions as described below and as illustrated in FIG. 1.
Exterior Film 100: 100 wt.-% of a 44 gauge biaxially oriented polyethylene terephthalate crystalline polyethylene terephthalate (OPET)-SARAfil TFCO (Polyplex Corporation, Uttar Pradesh, India).
Polyurethane Adhesive 200: 100 wt-% of a solventless, two-component polyurethane adhesive-MOR-FREE™ 403A/MOR-FREE™ C-117 (The Dow Chemical Company, Midland, Mich.).
Adhesive-contact layer 301:90 wt.- % of a low density polyethylene (LOPE) having a melt index of 2.3 gram/10 min, a density of 0.929 gram/cm³ and a melting point of 11T C-ExxonMobil™ LOPE LD 129.24 (ExxonMobil Chemical Company, Houston, Tex.), and 10 wt.- % of a linear low density polyethylene (LLDPE) having a melt index of 0.9 gram/10 min, a density of 0.921 gram/cm³ and a melting point of 120 C-DOWLEX™ 2645G (The Doer Chemical Company, Midland, Mich.).
Diisocyanate-Scavenging Layer 302: 50 wt.- % of an ethylene-based hexene elastomer, a metallocene polyethylene (ExxonMobil EXACT™ 3040) having a melt index of 17 gram/10 min., a density of 0.900 gram/cm³ and a melting point of 95′ C supplied by ExxonMobil Company (Houston, Tex.) and 50 wt- % of the EXACT™ 3040 m-PE/Inositol masterbatch described herein above. Total amount of non-polymeric polyol was 2 wt.- % relative to the total weight of this layer.

Product-Contact Layer 303: 100 wt.- % of a low density polyethylene (LDPE) having a melt index of 2.3 gram/10 min, a density of 0.929 gramicm³ and a melting point of 117° C.-ExxonMobil™ LDPE LD 129.24 (ExxonMobil Chemical Company, Houston, Tex.).

### Control Example

In the following Control Example, the thickness of the total exterior film 100 was 12.7 microns (0.5 mil), the total thickness of the polyurethane adhesive 200 was between 1.27 and 12.7 microns (0.05 and 0.5 mil), and the total thickness of monolayer interior film 300 was about 25.4 micron (1 mil).
Exterior Film 100: 100 wt.- % of a 44 gauge biaxially oriented polyethylene terephthalate crystalline polyethylene terephthalate (OPET)-SARAfil TFCO (Polyplex Corporation, Uttar Pradesh, India).
Polyurethane Adhesive 200: 100 wt.- % of a solventless, two-component polyurethane adhesive-MOR-FREE™ 403A/MOR-FREE™ C-117 (The Dow Chemical Company, Midland, Mich.)
Exterior Film-300: 100 wt.- % of a ultra-low density polyethylene (ULDPE) having a melt index of 0.8 gram/10 min, a density of 0.914 gram/cm³ and a melting point of 101° C. (214° F.)-ATTANE™ NG 47010 (The Dow Chemical Company, Midland, Mich.),

Reported below are the primary aromatic amines (2,2′-MDA; 2,4′-MDA and 4,4′-MDA) extraction results for Example 1 and Control Example by HPLC/MS spectroscopy taken after 24 hours post-lamination-TABLE 1; after 48 hours post-lamination-TABLE 2; and after 72 hours post-lamination-TABLE 3.

TABLE 1
Extractable Primary Aromatic Amines at 24 Hours

| | 4,4′-MDA | 2,4′-MDA | 2,2′-MDA | Total MDAs |
|---|---|---|---|---|
| Cure Time | (ppb) | (ppb) | (ppb) | (ppb) |
| Control | 4.88 | 107 | 41.97 | 153.85 |
| Example 1 | <0.41 | 10.35 | 36.5 | 47.25 |

TABLE 2
Extractable Primary Aromatic Amines at 48 Hours

| | 4,4′-MDA | 2,4′-MDA | 2,2′-MDA | Total MDAs |
|---|---|---|---|---|
| Cure Time | (ppb) | (ppb) | (ppb) | (ppb) |
| Control | <0.40 | 15.17 | 11.27 | 26.84 |
| Example 1 | <0.40 | <0.40 | 7.09 | 7.89 |

TABLE 3
Extractable Primary Aromatic Amines at 72 Hours

| | 4,4′-MDA | 2,4′-MDA | 2,2′-MDA | Total MDAs |
|---|---|---|---|---|
| Cure Time | (ppb) | (ppb) | (ppb) | (ppb) |
| Control | <0.40 | 4.5 | 16.3 | 21.2 |
| Example 1 | <0.40 | <0.40 | 10.1 | 10.9 |

The above-described data demonstrate the efficiency of the packaging laminates of the present invention in reducing the level of primary aromatic amines to acceptably low levels, within a short period of time, to eliminate long storage times.

The above description and examples illustrate certain embodiments of the present invention and are not to be interpreted as limiting. Selection of particular embodiments, combinations thereof, modifications, and adaptations of the various embodiments, conditions and parameters normally encountered in the art will be apparent to those skilled in the art and are deemed to be within the spirit and scope of the present invention.

What is claimed is:

1. A packaging laminate comprising:
an exterior film
a multilayer interior film comprising a diisocyanate-scavenging layer and an adhesive-contact layer;
a polyurethane adhesive layer bonding the exterior film to the adhesive-contact layer of the multilayer interior film;
wherein the diisocyanate-scavenging layer comprises a non-polymeric polyol.

2. The packaging laminate according to claim 1, wherein the non-polymeric polyol has at least three pendant hydroxyl groups.

3. The packaging laminate according to claim 1, wherein the non-polymeric polyol has at least four pendant hydroxyl groups.

4. The packaging laminate according to claim 1, wherein the non-polymeric polyol has a melting point of at least 200° C. (392° F.).

5. The packaging laminate according to claim 1, wherein the non-polymeric polyol is a monosaccharide, a disaccharide or an oligosaccharide.

6. The packaging laminate according to claim 1, wherein the non-polymeric polyol is a cyclodextrin.

7. The packaging laminate according to claim 1, wherein the non-polymeric polyol is defined by the generic chemical structure:

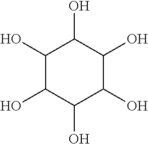 [SMILES: OC1C(O)C(O)C(O)C(O)C1O]

8. The packaging laminate according to claim 7, wherein the non-polymeric polyol is (1R, 2R, 3S, 45, 5R, 6S)-cyclohexane-1, 2, 3 4, 5, 6-hexol.

9. (canceled)

10. The packaging laminate according to claim 1, wherein the diisocyanate-scavenging layer comprises a blend of a polyolefin and the non-polymeric polyol.

11. The packaging laminate according to claim 10, wherein the polyolefin comprises high density polyethylene, low density polyethylene, linear low density polyethylene, ethylene/α-olefin copolymer, ethylene vinyl acetate copolymer, polypropylene, polybutylene and blends thereof.

12. The packaging laminate according to any of claim 1, wherein the diisocyanate-scavenging layer comprises between 1.0 wt.- % (10,000 ppm) and 5 wt.- % (50,000 ppm) of the non-polymeric polyol relative to the total weight of the diisocyanate-scavenging layer.

13. The packaging laminate according to any of claim 1, wherein the diisocyanate-scavenging layer comprises a urethane-type compound.

14. The packaging laminate according to claim 1, further comprising a separate product-contact layer in the multilayer interior film, wherein the diisocyanate-scavenging layer is disposed between the product-contact layer and the adhesive-contact layer.

15. The packaging laminate according to claim 14, wherein the diisocyanate-scavenging layer is in direct contact with the adhesive-contact layer.

16. The packaging laminate according to any of claim 1, further comprising a separate product-contact layer in the multilayer interior film, wherein the diisocyanate-scavenging layer is in direct contact with the product-contact layer and the adhesive-contact layer.

17. The packaging laminate according to claim 1, wherein the polyurethane adhesive comprises a two-component polyurethane adhesive.

18. The packaging laminate according to claim 17, wherein the two-component polyurethane adhesive comprises a diisocyanate and a polyol.

19. The packaging laminate according to claim 17, wherein the two-component polyurethane adhesive comprises an aromatic diisocyanate and a polyol.

20. The packaging laminate according to claim 1, wherein the exterior film comprises an exterior film layer comprising oriented polyethylene terephthalate, oriented polypropylene or oriented polyamides.
